(19) United States
(12) Patent Application Publication
(10) Pub. No.: US 2024/0330757 A1
(43) Pub. Date: Oct. 3, 2024

(54) DEFENSE FROM MEMBERSHIP INFERENCE ATTACKS IN TRANSFER LEARNING

(71) Applicant: INTERNATIONAL BUSINESS MACHINES CORPORATION, ARMONK, NY (US)

(72) Inventors: Mustafa Safa Ozdayi, Richardson, TX (US); Swanand Ravindra Kadhe, San Jose, CA (US); Yi Zhou, San Jose, CA (US); Nathalie Baracaldo Angel, San Jose, CA (US)

(21) Appl. No.: 18/194,603

(22) Filed: Mar. 31, 2023

(51) Int. Cl. G06N 20/00

(52) U.S. Cl. CPC G06N 20/00

(57) ABSTRACT

A computer-implemented method of training a machine learning model to prevent data leakage from membership inference attacks. A pre-trained model and a pre-defined hyperparameter λ are received as an input. A forward pass is applied by querying the pre-trained model with a private data. An initial loss distribution L_{INIT} of loss values is computed. A batch loss of a minibatch from the private data is computed after beginning a fine-tuning operation to transform the pre-trained model into a fine-tuned model, and a batch loss distribution L_{BATCH} is computed. A divergence metric is computed between L_{INIT} and L_{BATCH}, and the output of the divergence metric is multiplied with the pre-defined hyperparameter A to obtain a result that is added to the batch loss as a regularizer. The model parameters are updated by computing backpropagation on the regularized loss. The fine-tuned model is output.

### BACKGROUND

### Technical Field

The present disclosure generally relates to machine learning including transfer learning. More particularly, the present disclosure relates to membership inference attacks in transfer learning.

### Description of the Related Art

Transfer learning is a supervised learning technique in which a portion of a previously trained network is used on a different dataset for a different but similar problem. Foundation models, which are sometimes referred to as transformer-models, are typically large artificial intelligence models trained on a quantity of unlabeled data at scale (usually by self-supervised learning). The foundation models may be fine-tuned by a process including a pre-trained model. Such transformer-based foundation models may be adapted for application in a variety of tasks using transfer learning . . . .

FIG. 1A illustrates an image processing deep learning dataset 100A that includes a group of patients with brain abnormalities. An input image 101 has a portion of the image analyzed by a series of layers of a neural network (e.g., convolutional neural network (CNN) or a Recurrent Neural Network (RNN)). The layers of the CNN include a convolution layer 105, a rectified linear unit (RELU) layer 110, a pooling layer 115, a fully connected layer 120 and output classes 125 (e.g., stroke, tumor, and normal). Each of the aforementioned layers perform tasks in the image processing to identify whether an abnormality exists based on a model. If a hacker learns there is a membership of a person in such a dataset, they can infer that a person has a brain abnormality with a high degree of certainty. The leakage of such information may violate the strict requirements placed by privacy laws and regulations.

With reference to FIG. 1B, there is an illustration 100B of a problem regarding trained models (including but not limited to foundation models) being vulnerable to a membership inference attack (MIA). In an MIA, an adversary observes the model's output, e.g., confidence levels for each of the classes, and trains a set of shadow models capable of predicting the membership of a data sample. A target model 140 receives training data from a training set 130. An adversary 135 obtains query access to a trained model. With the query access, the adversary 135 tries to infer whether a sample is in a training set. MIAs are used by the adversary 135 to attack training models because sensitive properties and attributes can be inferred by the adversary 135, thereby violating privacy laws. As discussed above with regard to the CNN used in FIG. 1A, MIAs used to violate privacy protections likely violate the Health Insurance Portability and Accountability Act (HIPAA).

In a financial setting, there may be a fiduciary duty to keep certain financial information private, and an MIA may be used to breach this privacy. As privacy laws and regulations sometimes place strict requirements on machine learning systems, MIAs may be used to violate those requirements. There is a need to increase the security of data used in machine learning operations to reduce or prevent data leakage from MIAs.

### SUMMARY

According to one embodiment, a computer-implemented method of training a machine learning model to prevent data leakage from membership inference attacks. A pre-trained model and a pre-defined hyperparameter λ are received as an input. A computer-implemented method of training a machine learning model to prevent data leakage from membership inference attacks. A pre-trained model and a pre-defined hyperparameter λ are received as an input. A forward pass is applied by querying the pre-trained model with a private data. An initial loss distribution L_{INIT} of loss values in computed. A batch loss of a minibatch from the private data is computed after beginning a fine-tuning operation to transform the pre-trained model into a fine-tuned model. A divergence metric is computed between L_{INIT} and L_{BATCH}, and the output of the divergence metric is multiplied with the pre-defined hyperparameter A to obtain a result that is added to the batch loss as a regularizer. The model parameters are updated by computing backpropagation on the regularized loss. The fine-tuned model is output. The querying of the pretrained model with private data to get an initial loss distribution and the adding of a regularization term to penalize a distance between training and an initial loss distribution makes member and non-member distributions less distinguishable to an adversary, and thus less vulnerable to MIA attacks.
In one or more embodiments, logit-scaling is applied to the loss values. The logit scaling assists in data transformation to reduce data leakage.

In one or more embodiments, the modeling of the L_{INIT} as a first Gaussian Random Variable is performed by computing a mean and a variance of the logit-scaled loss values. The mean and the variance aid in providing a Gaussian variable.

In one or more embodiments, logit-scaling is applied to the batch loss values, and the modeling of the L_{BATCH} as a second Gaussian Random Variable is performed by computing the mean and variance of the logit-scaled batch loss. The logit scaling also aids in obtaining a Gaussian random variable of the minibatch losses to make an MIA attack more difficult for an adversary.

In one or more embodiments, the computing of the divergence metric between L_{INIT} and L_{BATCH} includes using a Kullback-Leibler divergence to measure a distance between L_{INIT} and L_{BATCH}. Kullback-Leibler (KL) divergence is a method useful to measure a distance between two probability distributions.

In one or more embodiments, prior to outputting the fine-tuned model, the updating of the model parameters by computing a backpropagation is performed using an update rule, and the method further includes determining that the fine-tuned model meets a termination criterion. Backpropagation improves the accuracy of the training of neural networks and assists in calculating an error function.

In one or more embodiments, the computing of the backpropagation to update the fine-tuned model is performed using a Stochastic Gradient Descent (SGD). SGD is used to adjust the parameters in machine learning to decrease an error rate.

In one or more embodiments, the computing of the backpropagation to update the fine-tuned model is performed using an adaptive learning rate method (Adam). Adam is an optimization algorithm that may be used to decrease an error rate.

In one or more embodiments, the training of the fine-tuned model occurs in a federated learning setting; and the output of the fine-tuned model is provided to an aggregation server. Privacy of data in federated learning is better protected from data leakage by making it more difficult for an adversary to learn membership information, particularly as the models are shared.

In one or more embodiments, the pre-defined value of the hyperparameter λ is varied to change the privacy-robustness values of the training model. The setting of the robustness of the model against different types of MIAs (e.g., directed to white box, confidence-based scores, or label-only) may be a tradeoff with regard to privacy. Changing the value of the hyperparameter may increase (or decrease) the robustness of the training model against MIAs but the test accuracy may change.

According to one embodiment, a computing device configured to train a machine learning model and prevent data leakage from membership inference attacks includes a processor; and a memory coupled to the processor, the memory storing instructions to cause the processor to perform acts including receiving a pre-trained model and a pre-defined hyperparameter λ as an input. A forward pass is applied by querying the pretrained model with a private data. An initial loss distribution L_{INIT} of a plurality of loss values is computed A batch loss of a minibatch from the private data is computed after beginning a fine-tuning operation to transform the pre-trained model into a fine-tuned model, and a loss distribution L_{BATCH} of the batch loss is computed. A divergence metric between L_{INIT} and L_{BATCH} is computed. An output of the divergence metric is multiplied with the pre-defined hyperparameter A to obtain a result, and the result is added to the batch loss as a regularizer. The model parameters are updated by computing backpropagation on the regularized loss, and the fine-tuned model is output. The querying of the pretrained model with private data to get an initial loss distribution and the adding of a regularization term to penalize a distance between training and initial loss distribution makes member and non-member distributions less distinguishable to thwart MIA attacks.

According to one embodiment, a computer program product includes one or more computer-readable storage devices and program instructions stored on at least one of the one or more computer-readable storage devices, the program instructions executable by a processor and include instructions to receive a pre-trained model and a pre-defined hyperparameter λ as an input; program instructions to apply a forward pass by querying the pretrained model with a private data; program instructions to compute an initial loss distribution L_{INIT} of a plurality of loss values; program instructions to compute a batch loss of a minibatch from the private data after beginning a fine-tuning operation to transform the pre-trained model into a fine-tuned model. There are also provided program instructions to compute a divergence metric between L_{INIT} and L_{BATCH} and multiply an output of the divergence metric with the pre-defined hyperparameter A to obtain a result, and to add the result to the batch loss as a regularizer. The model parameters are updated by computing backpropagation on the regularized loss, and the fine-tuned model is output. The instructions when executed make the loss distributions of members and non-members less distinguishable to thwart MIA attacks.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A illustrates an input image from a dataset processed by a Convoluted Neural Network.

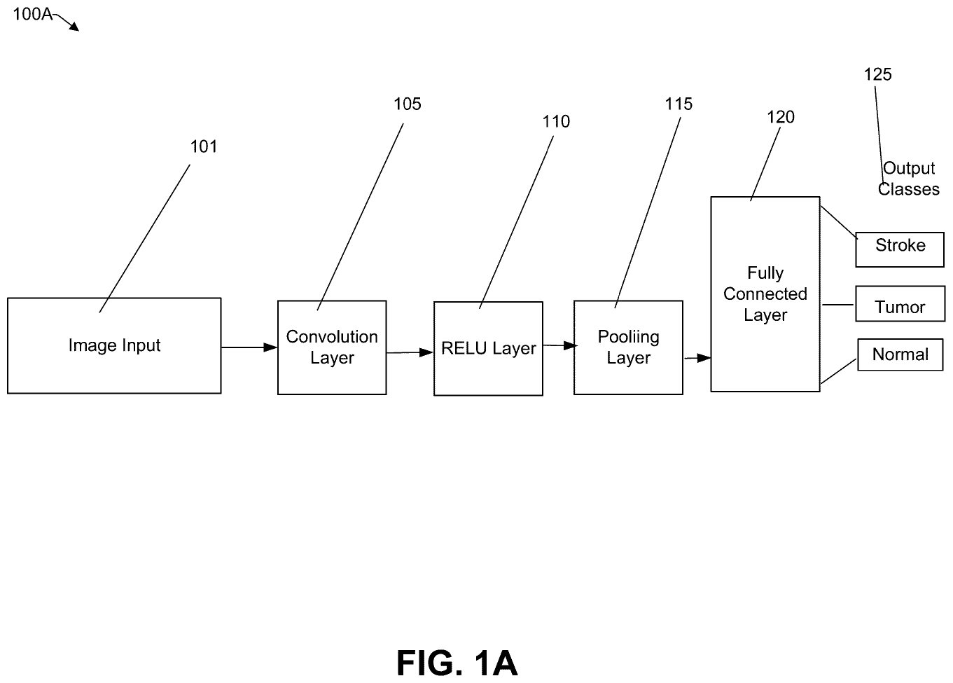

FIG. 1B illustrates a Membership Inference Attack against a training model with conventional safeguards.

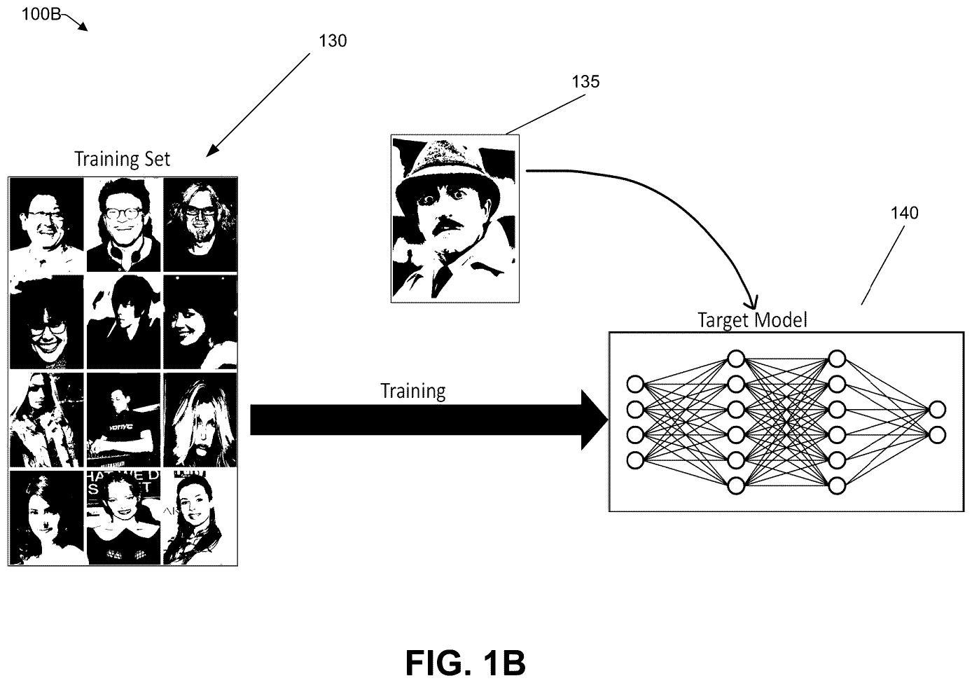

FIG. 2 illustrates a Membership Inference Attack (MIA) in transfer learning of a target model.

FIG. 3 illustrates some of the ways that an adversary queries a model to perform an MIA.

FIG. 4 illustrates a defense for MIAs during transfer learning, consistent with an illustrative embodiment.

FIG. 5 illustrates a loss modeling distribution, consistent with an illustrative embodiment.

FIG. 6 illustrates a group of results on a first dataset, consistent with an illustrative embodiment.

FIG. 7 illustrates a group of results on a second dataset, consistent with an illustrative embodiment.

FIG. 8 is a graph illustrating privacy-robustness trade-offs by varying λ, consistent with an illustrative embodiment.

FIG. 9 is a graph illustrating a convergence speed in a defense for transfer learning versus a conventional defense technique, consistent with an illustrative embodiment.

FIG. 10 is a flowchart illustrating operations for a computer-implemented method of a defense for transfer learning, consistent with an illustrative embodiment.

FIG. 11 illustrates a block diagram of a computing environment in accordance with an illustrative embodiment.

### DETAILED DESCRIPTION

In the following detailed description, numerous specific details are set forth by way of examples to provide a thorough understanding of the relevant teachings. However, it is to be understood that the present teachings may be practiced without such details. In other instances, well-known methods, procedures, components, and/or circuitry have been described at a relatively high-level, without detail, to avoid unnecessarily obscuring aspects of the present teachings. It is also to be understood that the present disclosure is not limited to the depictions in the drawings, as there may be fewer elements or more elements than shown and described.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

As used herein, “compatibility” refers to software components which can operate satisfactorily (without failure or degradation) together on a same computer, a computing cluster, or on different computers linked by a network.

As used herein, the term “loss” refers to a value that represents the summation of errors in the model. If the models has a relatively high number of errors, the loss will be high. If the model has relatively fewer errors, the loss is low and the model is operating more efficiently. In a training set used in a model, members and non-members have different loss distributions. The difference in loss distributions can be used to determine members from non-members of a dataset.

As used herein, the term “regularization” refers to a technique to reduce errors by fitting a function on a training set, and to avoid overfitting or underfitting. Regularization reduces the variance of a model, and does not substantially increase bias A tuning hyperparameter (e.g., A) is used to change the variance of the model.

As used herein, “adaption fine-tuning” refers to a type of transfer learning in which a distribution of a model is shifted to be closer to the distribution of target data.

As used herein, the term “termination criterion” is to be understand as any item that results in the ending of fine-tuning a model. For example, a certain number of passes (epochs) of the training function, a safeguard for an overfitting condition, a loss distribution rate, etc., are some of the items that may be used to terminate the fine tuning of the model.

It is to be understood that other embodiments may be used and structural or logical changes may be made without departing from the spirit and scope defined by the claims. The description of the embodiments is not limiting. In particular, elements of the embodiments described hereinafter may be combined with elements of different embodiments.

### Overview

Training models are susceptible to MIAs because the loss value of a sample can be a signal for membership. According to the present disclosure, a method and computing device operate to make member and non-member loss distributions less distinguishable.

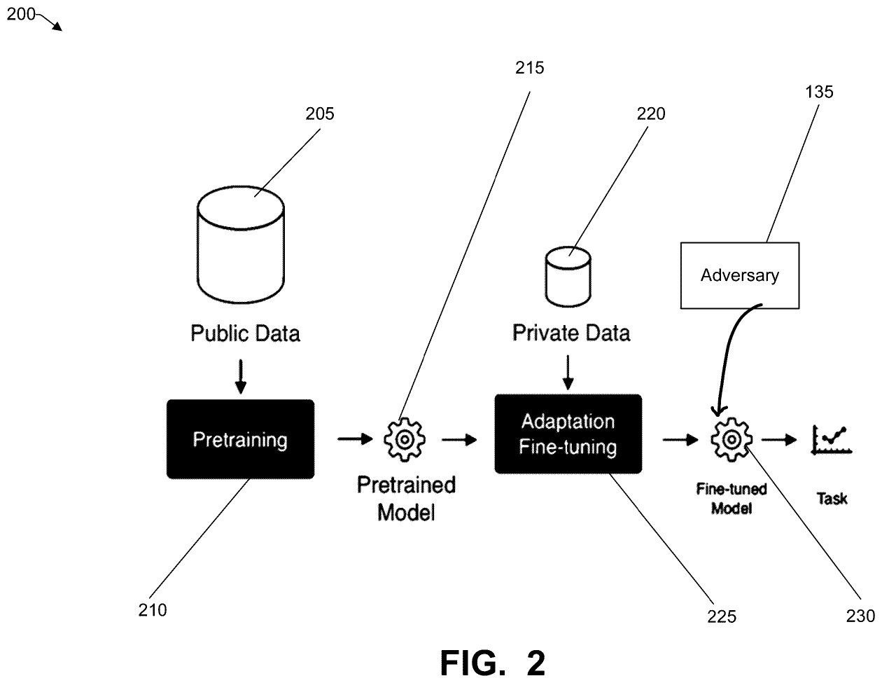

FIG. 2 illustrates a Membership Inference Attack in transfer learning of a target model. Transfer learning starts with a pretraining operation 210 of a pretrained model 215 using data (e.g., public data 205). The pretrained model 215 undergoes a fine-tuning 225 on private data 220. An adversary 135 tries to infer membership with respect to the private data 220 by interacting with the fine-tuned model 230. The present disclosure prevents the adversary from learning membership information with respect to the private data.

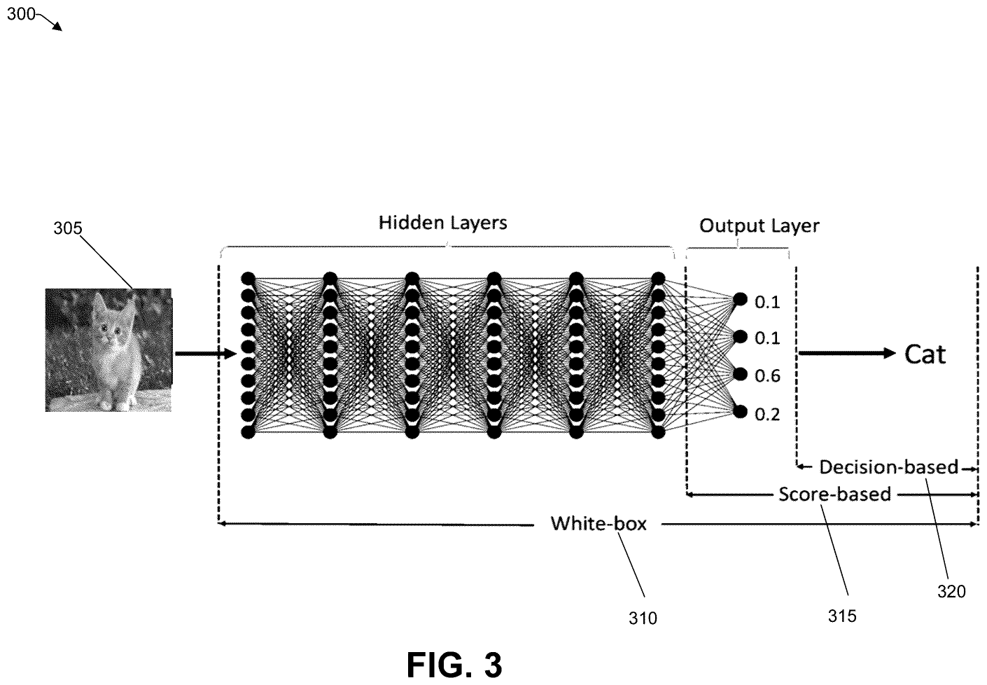

FIG. 3 illustrates some of the ways that an adversary queries a model to perform an MIA. An image 305 is processed by the model, and the adversary utilizes any of the white box 310, confidence scores 315 or decision based 320. Conventional methods to stop adversaries from using any of the white box 310, confidence scores 315 or decision based 320 MIAs have not been successful in preventing data leakage.

The present disclosure provides a computer-implemented method and computer device for the defense against MIAs during transfer learning. In an illustrative embodiment, two changes are made to a transfer learning pipeline to make a fine-tuned model robust against MIAs. One change is prior to beginning fine-tuning of the model, the pretrained model is queried with private data to obtain an initial loss distribution. The second change is during fine-tuning, a regularization term is added to penalize a distance between training and the initial loss distribution. These changes provide for a more robust defense against MIAs, and provides for a more efficient user of computer resources. For example, compared with known defenses against MIAs, the convergence speed is faster with the same accuracy value in a shorter number of epochs. The computer-implemented method and device according to the present disclosure provides an improvement in the reliability of computer operations in the field of model training (including but not limited to foundation model training), and an improvement in the accuracy, speed and operation of computers used in the machine learning processes. There are fewer computer resources used with a better, more robust defense against different types of MIAs.

### Example Embodiments

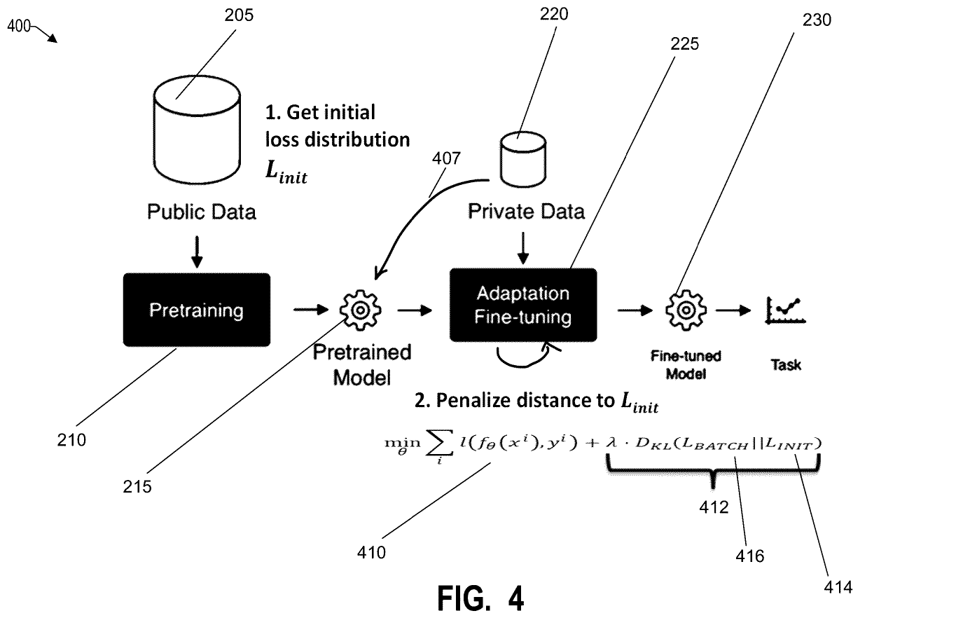

FIG. 4 illustrates a defense for MIAs during transfer learning, consistent with an illustrative embodiment. It is to be understood that the private data 220 shown in FIG. 4 is non-membership data with respect to the pretrained model 215. An initial loss distribution L_{INIT} of the loss values is computed by querying the pretrained model with the private data 220. A forward pass 407 on the private data 220 on the pretrained model 215 is shown to obtain loss values. Then during the fine tuning 225 (transfer learning using the private data to transform the pre-trained model 215 into a fine-tuned model 230), a loss distribution function 410 that may be used in transfer learning is augmented with a regularization term 412 (shown by the bracket), which includes the initial loss distribution L_{INIT} 414 in conjunction with the current loss distribution (L_{BATCH} 416). Such a loss distribution function 410 with a regularization term 412 augmenting the loss distribution function 410, such as shown in FIG. 4, is reproduced herein below:

$${min}_{θ} {\sum }_{i} l ( {f}_{θ} ( {x}^{i} ) , {y}^{i} ) + \underbrace{λ \cdot {D}_{KL} ( {L}_{BATCH} \vert \vert {L}_{INIT} )}$$

(Eqn. 1) where xⁱ denotes a training sample (e.g., an image) and yⁱ denotes its label; f_{θ}(xⁱ) denotes the prediction of the machine learning model, which is parameterized by θ; and I (f_{θ}(xⁱ), yⁱ) denotes the loss function between the model's prediction and the label (e.g., a cross-entropy function).

In the bracketed portion above, lambda λ is the hyperparameter value, DKL is the Divergence Metric (in this example it is Kullback-Leibler (KL) metric) of the distance between L_{BATCH} and L_{INIT}. Other divergence metrics may be used and the present disclosure is not limited to the KL metric.

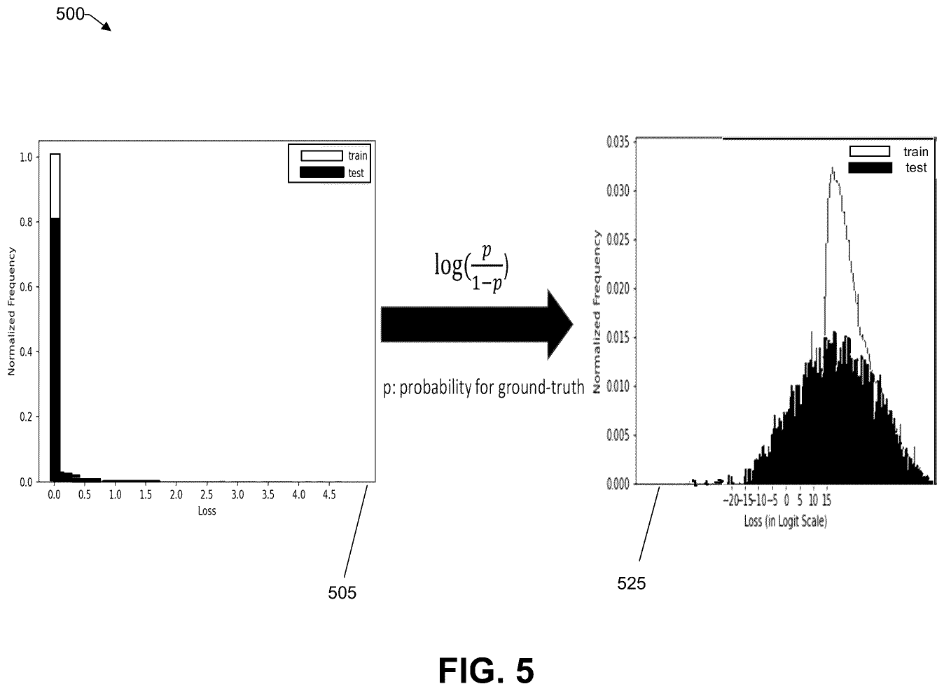

FIG. 5 illustrates a loss modeling distribution, consistent with an illustrative embodiment. To compute the divergence between an initial loss and a batch loss, modeling of the loss distributions is performed. In this illustrative embodiment, a logit-scaling technique is leveraged to model the loss distributions as Gaussian distributions. Modeling the loss distributions as Gaussian enables the use of different types of divergence metrics in closed form to make the present method computationally efficient. Is to be understood that the present disclosure is not limited to a logit-scaling technique, even though logit-scaling has certain advantages such as computational efficiency. Graph 505 shows normalized frequency versus loss without the use of logs. Graph 525 shows the normalized frequency versus loss in logit scale (by using the log (p/1-p), with p being the probability for ground-truth.

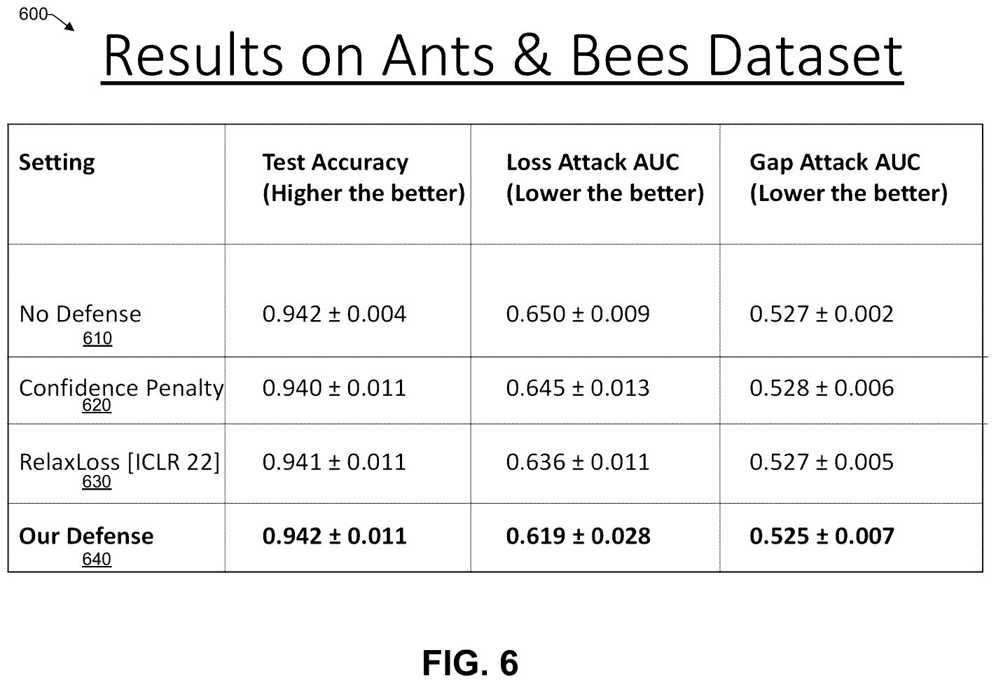

FIG. 6 illustrates a group of results 600 on a first dataset, consistent with an illustrative embodiment. The first dataset are the results of training models “Ants and Bees” with No Defense 610 against MIAs, a Confidence Penalty 620 (based on confidence scores), RelaxLoss 630 (a known system to reduce MIAs) and “Our Defense” 640 is the method of the present disclosure. The categories are Test Accuracy, Loss Attack Area under the curve (AUC) and Gap Attack AUC. Our Defense 640 was tied for the highest test accuracy, and had significantly lower loss attack AUC and Gap attack AUC. Thus, the method to defend against MIAs in transfer learning provide robust protect against loss attacks (e.g., confidence scores) and gap attacks (label-only) with little if any effect on the test accuracy.

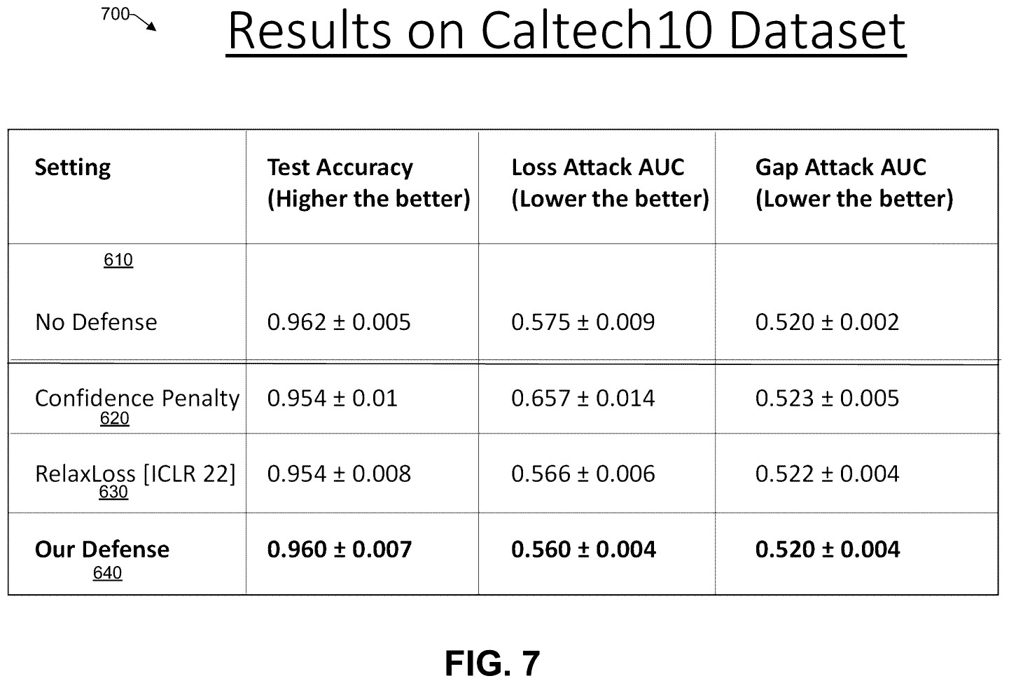

FIG. 7 illustrates a group of results 700 on a second dataset, consistent with an illustrative embodiment. The second data are the results of “Caltech 10 Dataset” with No Defense 61 against MIAs. A Confidence Penalty 620, RelaxLoss 630, and “Our Defense” 640 of the present disclosure. The method of the present disclosure (“Our Defense” 640) had the second highest test accuracy, and the lowest loss attack AUC and tied for the lowest Gap attack.

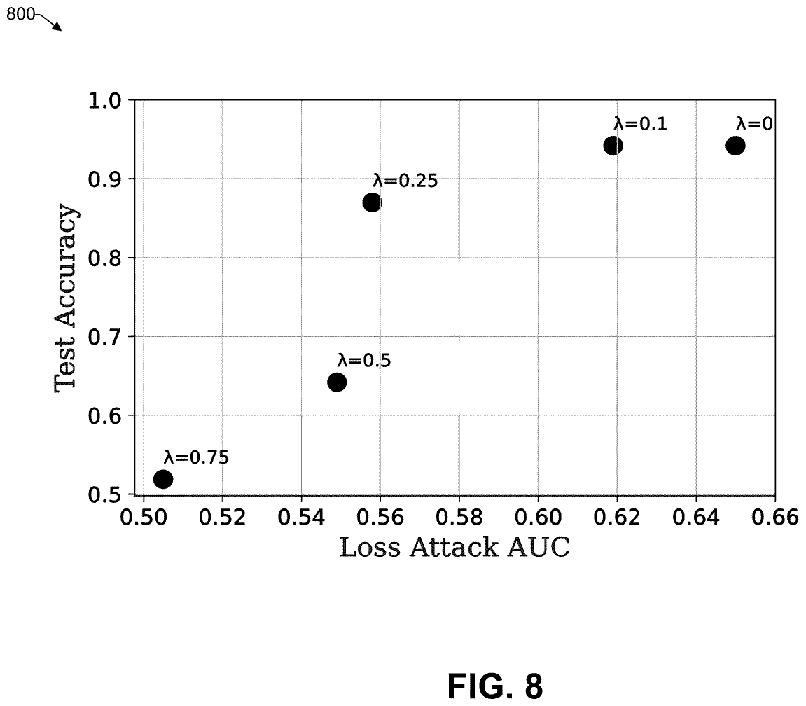

FIG. 8 is a graph illustrating privacy-robustness trade-offs by varying λ, consistent with an illustrative embodiment. The graph of FIG. 8 shows test accuracy versus loss attack (AUC). By reducing a value of the hyperparameter 2, the test accuracy increases and the loss attack decreases. By increasing the hyperparameter λ, the chance of a loss attack is reduced.

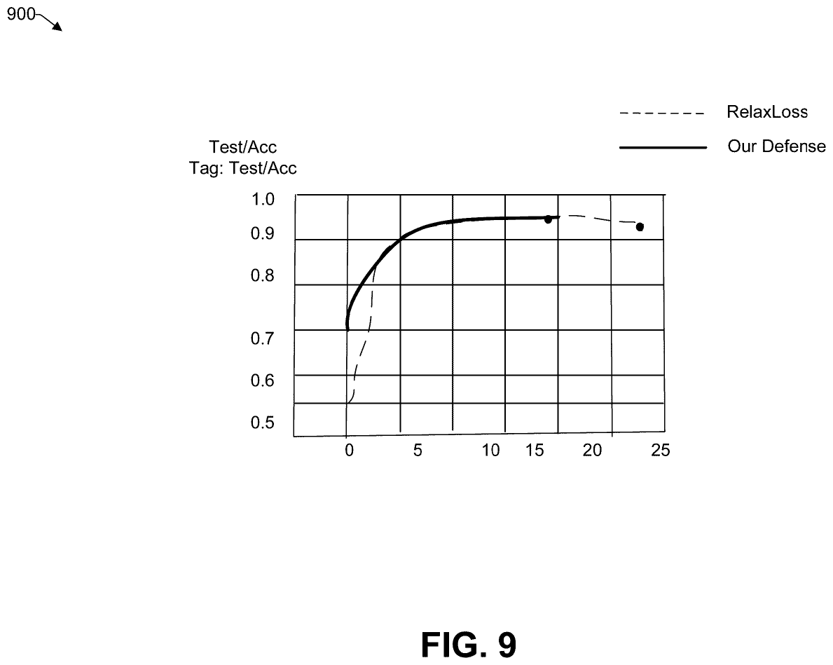

FIG. 9 is a graph 900 illustrating a convergence speed in a defense for MIA attacks during transfer learning versus a conventional defense technique, consistent with an illustrative embodiment. The solid line represents the method according to the present disclosure (“Our Defense”), and the dashed lines shows a graph of the conventional RelaxLoss method of defense. The Y Axis shows test accuracy, and the X axis shows epochs. It can be seen that the solid line (“Our Defense” according to the present disclosure) converged to the same accuracy value in a shorter number of epochs. The method of the present disclosure is more efficient as it achieves the same accuracy in fewer epochs, saving computer resources and time.

### Example Process

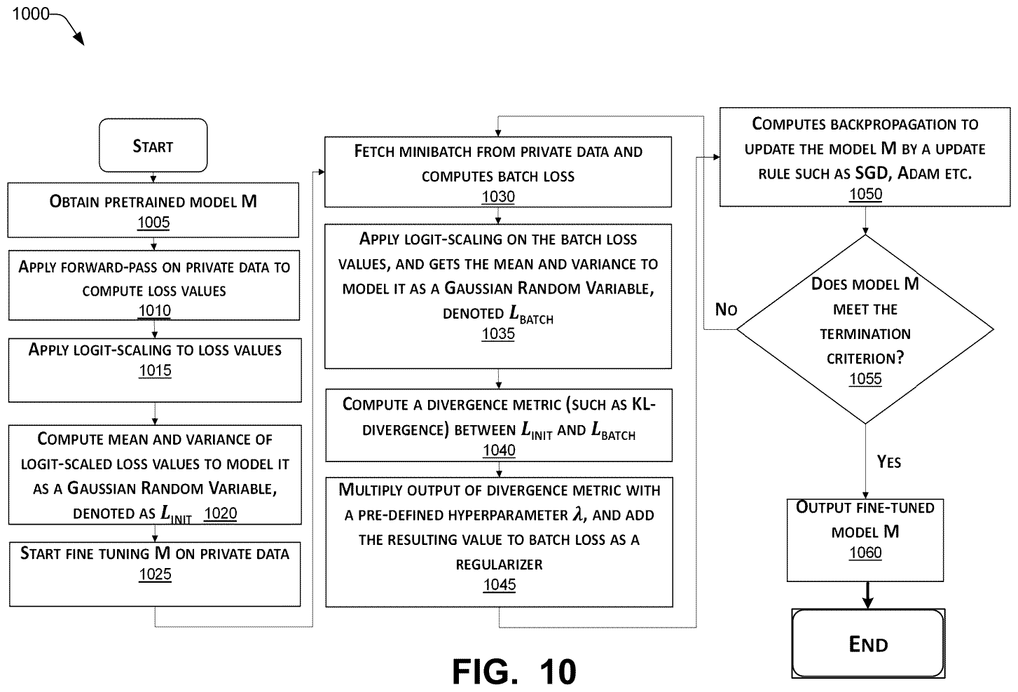

With the foregoing overview of the example architecture, it may be helpful now to consider a high-level discussion of an example process. To that end, FIG. 10 is a flowchart illustrating a computer-implemented method to defend against Membership Inference Attacks in transfer learning, consistent with an illustrative embodiment. It is to be understood that the process shown and described is provided for illustrative purposes.

FIG. 10 is shown as a collection of blocks, in a logical order, which represents a sequence of operations that can be implemented in a combination thereof.

A pre-trained Model M and a predefined hyperparameter λ are received (operation 1005). The pre-trained model is to be fine-tuned using private data. Prior to the start of fine-tuning, the pre-trained model is queried with private data to get an initial loss distribution by applying a forward pass on the private data to compute loss values (operation 1010). FIG. 4 shows the private data 220 is provided to the pretrained model 215.

Logit scaling is applied to the loss values (operation 1015). Although the present disclosure is not limited to using logit scaling, logit-scaling technique enables the modeling the loss distributions as Gaussian distributions. Modeling the loss distributions as Gaussian permits the use of different types of divergence metrics in closed form to make the present method more computationally efficient than by using other techniques.

The mean and variance of the logit scaled loss values are computed to model the distribution as a Gaussian random variable L_{INIT} (operation 1020). FIG. 5 shows in graph 525 a Gaussian distribution of training data and testing data using the logit scaling.

The fine tuning of the pretrained model M on private data starts (operation 1025). Fine-tuning is a component of foundation models, which are trained on large unlabeled datasets and fine-tuned for an array of applications. FIG. 4 shows a fine-tuning operation that transforms the pre-trained model 215 into a fine-tuned model 230, and additional iterations of the fine-tuning may occur to the fine-tuned model.

Minibatches are fetched from the private data and used to compute batch loss (operation 1030). Minibatches allow for the updating of the parameters of the model without waiting for the model to compute the entire dataset. If there are a significant number of errors (e.g., losses), the parameters can be changed quickly using minibatches so that the model is operating accurately and efficiently.

Logit scaling is then applied on the batch loss values, and the mean and variance of the logit scaled batch loss values are modeled as a Gaussian Random Variable L_{BATCH} (operation 1035). Now that the initial loss values and the batch loss values are known, the divergence may be computed.

A divergence metric is computed between L_{INIT} and L_{BATCH} (operation 1040). While a Kullback-Leibler (KL) is a divergence metric useful to measure a distance between two probability distributions, other types of divergence metrics may be used.

A multiplication of the output of the divergence metric with a pre-defined hyperparameter λ, and the resulting value of the multiplication is added to a batch loss as regularizer (operation 1045). Regularization reduces the variance of a model, and does not substantially increase bias. The pre-defined hyperparameter (2) may be used to change the variance of the model. The adding of a regularization term to penalize a distance between the training (L_{BATCH}) and initial loss (L_{INIT}) distribution makes member and non-member distributions less distinguishable to thwart MIA attacks.

Backpropagation is computed to update the Model MK by an update rule (operation 1050). Update rules include Stochastic Gradient Descent (SGD), or an adaptive learning rate method (Adam).

It is then determined whether the fine-tuned model meets the termination criterion (operation 1055). Termination criterion can be any item that results in the ending of fine-tuning a model. For example, a certain number of passes (epochs) of the training function, a safeguard for an overfitting condition, a loss distribution rate, etc., are some of the criterion that may be used to terminate the fine tuning of the model.

If the fine-tuned model does not meet the termination criterion at operation 1055, another backpropagation is computed to update the fine-tuned model by an update rule as previously discussed (operation 1050). However, if the fine-tuned model meets the termination criterion, the fined-tuned model is output and the method ends.

### Example Data Processing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

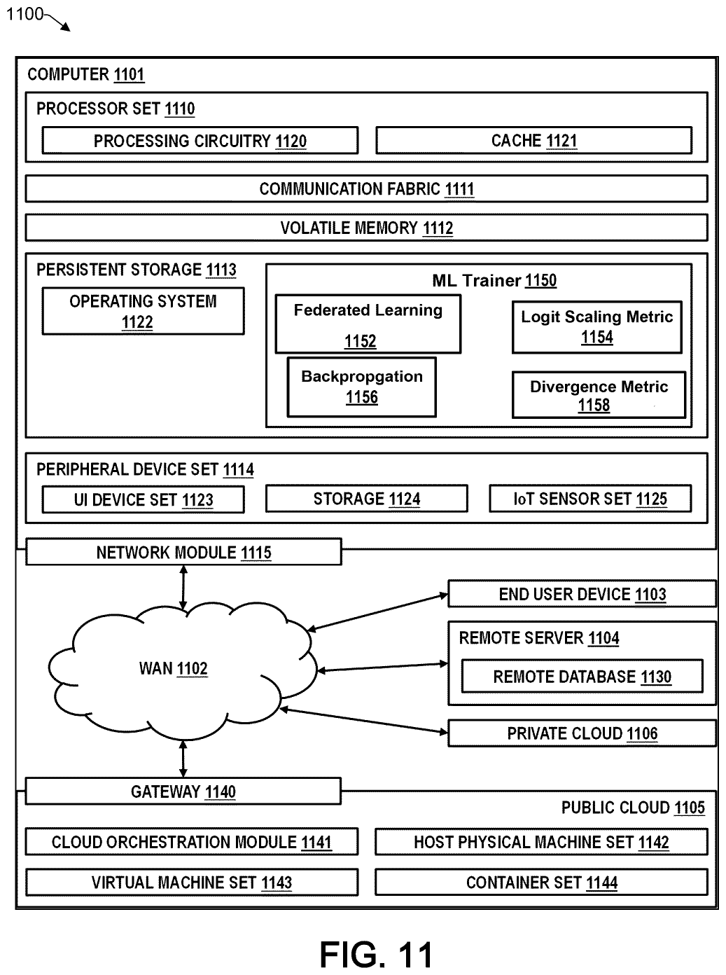

With reference to FIG. 11, the computing environment 1100 includes an example of an environment for the execution of at least some of the computer code involved in performing the inventive methods, such as the Machine Learning Trainer Module 1150, are at least some of the elements of the present disclosure. The Machine Learning (ML) trainer module 1150 controls operation of the federated learning module 1152, logit scaling metric 1154, backpropagation module 1156 and the divergence module 1158. The ML Trainer module 1150 trains models with public and private data, using transfer learning techniques that may be supervised or unsupervised. The federated learning module 1152 applies a training round iteration locally before sharing the model update with an aggregation server. The Logit scaling metric 1154 is applied to the loss values obtained from the forward pass. The logit scaling assists in data transformation to reduce data leakage. The modeling of the L_{INIT} is performed by computing the mean and variance of the logit-scaled loss values. The mean and the variance aid in providing a Gaussian variable. The logit scaling also aids in obtaining a Gaussian random variable of the minibatch losses to make an MIA attack more difficult for an adversary. Prior to outputting a fine-tuned model 230, the Backpropagation module 1156 is configured to update the pre-trained model 215 by an update rule, and to determine that the fine-tuned model 230 meets a termination criterion. The Divergence Metric module 1158 computes of the divergence metric between L_{INIT} and L_{BATCH}, and may include using a Kullback-Leibler divergence to measure a distance between L_{INIT} and L_{BATCH}.

In addition, computing environment 1100 includes, for example, Computer 1101, wide area network 1102 (WAN), end user device 1103 (EUD), remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and Install Advisor Engine 1162, as identified above), peripheral device set 1114 (including user interface (UI) device set 1123, storage 1124, and Internet of Things (IoT) sensor set 1125), and network module 1165. Remote server 1104 includes remote database 1130. Public cloud 1105 includes gateway 1140, cloud orchestration module 1141, host physical machine set 1142, virtual machine set 1143, and container set 1144.

Computer 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically Computer 1101, to keep the presentation as simple as possible. Computer 1101 may be located in a cloud, even though it is not shown in a cloud in FIG. 11. On the other hand, Computer 1101 is not required to be in a cloud except to any extent as may be affirmatively indicated.

Processor set 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto Computer 1101 to cause a series of operational steps to be performed by processor set 1110 of Computer 1101 and thereby effect a computer-implemented method, such that the instructions thus executed instantiates the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in the install advisor engine 1100 in persistent storage 1113.

Communication fabric 1111 is the signal conduction path that allows the various components of Computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1112 is any type of volatile memory now known or to be developed in the future. Examples include dynamic type random access memory (RAM) or static type RAM. Typically, volatile memory 1112 is characterized by random access, but this is not required unless affirmatively indicated. In Computer 1101, the volatile memory 1112 is located in a single package and is internal to Computer 1101, but, alternatively or additionally, the volatile memory may be distributed over multiple packages and/or located externally with respect to Computer 1101.

Persistent storage 1113 is any form of non-volatile storage for computers that is now known or to be developed in the future. The non-volatility of this storage means that the stored data is maintained regardless of whether power is being supplied to Computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface-type operating systems that employ a kernel. The code included in the Install Advisor Engine 1100 typically includes at least some of the computer code involved in performing the inventive methods.

Peripheral device set 1114 includes the set of peripheral devices of Computer 1101. Data communication connections between the peripheral devices and the other components of Computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where Computer 1101 is required to have a large amount of storage (for example, where Computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

Network module 1115 is the collection of computer software, hardware, and firmware that allows Computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to Computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 1103 is any computer system that is used and controlled by an end user (for example, a customer of an enterprise that operates Computer 1101) and may take any of the forms discussed above in connection with Computer 1101. EUD 1103 typically receives helpful and useful data from the operations of Computer 1101. For example, in a hypothetical case where Computer 1101 is designed to provide a recommendation to an end user, this recommendation would typically be communicated from network module 1165 of Computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

Remote server 1104 is any computer system that serves at least some data and/or functionality to Computer 1101. Remote server 1104 may be controlled and used by the same entity that operates Computer 1101. Remote server 1104 represents the machine(s) that collect and store helpful and useful data for use by other computers, such as Computer 1101. For example, in a hypothetical case where Computer 1101 is designed and programmed to provide a recommendation based on historical data, then this historical data may be provided to Computer 1101 from remote database 1130 of remote server 1104.

Public cloud 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1142 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of training a machine learning model to prevent data leakage from membership inference attacks, the method comprising:
receiving a pre-trained model and a pre-defined hyperparameter λ as an input for machine learning;
applying a forward pass by querying the pre-trained model with a private data;
computing an initial loss distribution L_{INIT} of a plurality of loss values;
computing a batch loss of a minibatch from the private data after beginning a fine-tuning operation to transform the pre-trained model into a fine-tuned model, and computing a loss distribution L_{BATCH} of the batch loss;
computing a divergence metric between L_{INIT} and L_{BATCH}; and
multiplying an output of the divergence metric with a pre-defined hyperparameter λ to obtain a result;
adding the result to the batch loss as a regularizer;
updating a model parameters by computing backpropagation on the regularized batch loss; and
outputting the fine-tuned model.

2. The computer-implemented method according to claim 1, further comprising applying logit-scaling to the plurality of loss values.

3. The computer-implemented method according to claim 2, further comprising performing a modeling of the L_{INIT} as a first Gaussian Random Variable by computing a mean and a variance of the logit-scaled loss values.

4. The computer-implemented method according to claim 3, further comprising applying logit-scaling to the batch loss, and wherein the modeling of the L_{BATCH} as a second Gaussian Random Variable is performed by computing a mean and a variance of the logit-scaled batch loss.

5. The computer-implemented method according to claim 4, wherein computing the divergence metric between L_{INIT} and L_{BATCH} comprises using a Kullback-Leibler divergence to measure a distance between L_{INIT} and L_{BATCH}.

6. The computer-implemented method according to claim 4, wherein the updating of the model parameters by computing the backpropagation is performed by using an update rule, and the method further comprising:
determining, prior to outputting, that the fine-tuned model meets a termination criterion.

7. The computer-implemented method according to claim 6, wherein the computing of the backpropagation to update the model parameters is performed using a Stochastic Gradient Descent (SGD).

8. The computer-implemented method according to claim 6, wherein the computing of the backpropagation to update the model parameters is performed using an adaptive learning rate method (Adam).

9. The computer-implemented method according to claim 1,
wherein the fine-tuning operation of the pre-trained model occurs in a federated learning setting, and the method further comprising:
providing the output of the fine-tuned model to an aggregation server.

10. The computer-implemented method according to claim 1, further comprising varying a pre-defined value of the hyperparameter λ to change a privacy-robustness values of the training model.

11. A computing device configured to train a machine learning model and prevent data leakage from membership inference attacks, the computing device comprising:
a processor; and
a memory coupled to the processor, the memory storing instructions to cause the processor to perform acts comprising:
receiving a pre-trained model and a pre-defined hyperparameter λ as an input;
applying a forward pass by querying the pre-trained model with a private data;
computing an initial loss distribution L_{INIT} of a plurality of loss values;
computing a batch loss of a minibatch from the private data after beginning a fine-tuning operation to transform the pre-trained model into a fine-tuned model, and computing a loss distribution L_{BATCH} of the batch loss;
computing a divergence metric between L_{INIT} and L_{BATCH};
multiplying an output of the divergence metric with a pre-defined hyperparameter A to obtain a result;
adding the result to the batch loss as a regularizer;
updating a model parameters by computing backpropagation of the regularized batch loss; and
outputting the fine-tuned model.

12. The computing device according to claim 11, wherein the instructions cause the processor to perform an additional act comprising applying logit-scaling to the plurality of loss values.

13. The computing device according to claim 12, wherein:
the instructions cause the processor to perform additional acts comprising applying logit-scaling to the batch loss;
performing a modeling of the L_{INIT} as a Gaussian Random Variable by computing a mean and a variance of the logit-scaled loss;
performing a modeling of the L_{INIT} as a first Gaussian Random Variable by computing a mean and a variance of the logit-scaled loss values; and
performing a modeling of the L_{BATCH} as a second Gaussian Random Variable by computing a mean and a variance of the logit-scaled batch loss.

14. The computing device according to claim 13, wherein the computing of the divergence metric between L_{INIT} and L_{BATCH} comprises using a Kullback-Leibler divergence to measure a distance between L_{INIT} and L_{BATCH}.

15. The computing device according to claim 13, wherein computing the backpropagation is performed by using an update rule, and the instructions cause the processor to perform an additional act comprising:
determining, prior to outputting, that the fine-tuned model meets a termination criterion.

16. The computing device according to claim 15, wherein the update rule for the computing of the backpropagation to update the model parameters is performed by a Stochastic Gradient Descent (SGD) or an adaptive learning rate method (Adam).

17. The computing device according to claim 15, wherein the instructions cause the processor to perform additional acts comprising:
training the fine-tuned model in a federated learning setting; and
providing the output of the fine-tuned model to an aggregation server that shares an update of fine-tuned model.

18. The computing device according to claim 15, wherein the instructions cause the processor to perform an additional act comprising varying a pre-defined value of the hyperparameter λ to change privacy-robustness values of the training model.

19. A computer program product comprising:
one or more computer-readable storage devices and program instructions stored on at least one of the one or more computer-readable storage devices, the program instructions executable by a processor, the program instructions comprising:
program instructions to receive a pre-trained model and a pre-defined hyperparameter λ as an input;
program instructions to apply a forward pass by querying the pre-trained model with a private data;
program instructions to compute an initial loss distribution L_{INIT} of a plurality of the loss values;
program instructions to compute a batch loss of a minibatch from the private data after beginning a fine-tuning operation to transform the pre-trained model into a fine-tuned model, and to compute a loss distribution L_{BATCH} of the batch loss;
program instructions to compute a divergence metric between L_{INIT} and L_{BATCH} and multiply an output of the divergence metric with a pre-defined hyperparameter A to obtain a result, and to add the result to the batch loss as a regularizer;
program instructions to update a model parameters by computing backpropagation on the regularized batch loss; and
program instructions to output the fine-tuned model.

20. The computer program product according to claim 19, further comprising:
program instructions to apply logit-scaling to the loss values obtained from the forward pass;
program instructions to perform a modeling of the L_{INIT} as a first Gaussian Random Variable by computing a mean and a variance of the logit-scaled loss values;
program instructions to apply logit-scaling to the batch loss, and to perform a modeling of the L_{BATCH} as a second Gaussian Random Variable by computing a mean and variance of the logit-scaled batch loss;
program instructions to compute the backpropagation to update the model parameters by using an update rule; and
program instructions prior to output of the fine-tuned model to determine that the fine-tuned model meets a termination criterion.
